(19) United States
(12) Patent Application Publication
(10) Pub. No.: US 2016/0237696 A1
(43) Pub. Date: Aug. 18, 2016

(54) Multilayer Decorative Plastic Web or Board and Process for Producing the Same

(71) Applicants: SAMTASTIC PRODUCTS GMBH, Mühlhausen im Täle (DE); SCHOELLER TECHNOCELL GMBH & CO. KG, Osnabrück (DE)

(72) Inventors: Jürgen Frommherz, Hüttlingen (DE); Thomas Hildenbrand, Göppingen (DE); Thomas Scheck, Pulaski, NY (US)

(21) Appl. No.: 15/030,181

(22) PCT Filed: Jul. 8, 2014
(86) PCT No.: PCT/EP2014/001873

§ 371 Date: Apr. 18, 2016

(30) Foreign Application Priority Data
Oct. 24, 2013 (DE) 20 2013 009 496.6

(51) Int. Cl. E04F 15/02; B32B 27/20; E04F 15/10; E04F 13/08; E04F 13/16; B32B 27/10; E04F 13/00

(52) U.S. Cl. CPC E04F 15/02038; B32B 27/10; B32B 27/20; E04F 13/002; E04F 13/0866; E04F 13/16; E04F 15/102; E04F 15/107; B32B 2260/028; B32B 2307/4026; B32B 2607/02; B32B 2471/00

(57) ABSTRACT

The present invention relates to a multilayer decorative plastic web or board, comprising a carrier sheet containing a thermoplastic material having at least one layer containing an impregnated paper provided on one or on both sides thereof, particularly near to the surface, as well as to a process for producing the same. The multilayer decorative plastic web or board according to the present invention can be suitably used for interior design, and in particular for ceilings, linings, wall panels, decorative films or synthetic veneers for furniture surfaces as well as for floor coverings.

The present invention relates to a multilayer decorative plastic web or board comprising a carrier sheet containing a thermoplastic material having at least one layer containing an impregnated paper provided on one or on both sides thereof, particularly near to the surface, as well as to a process for producing the same. The multilayer decorative plastic web or board according to the present invention can be suitably used for interior design, and in particular for ceilings, linings, wall panels, decorative films or synthetic veneers for furniture surfaces as well as for floor coverings.

Multilayer plastic webs based on polyvinylchloride (PVC) with a transparent cover layer as the wear layer, have been used for many decades as floor coverings. However, other plastics, i.e. polymers such as ethylene-vinyl acetate (EVA) copolymers, plastics based on olefinic polymers such as polyethylene (PE), polypropylene (PP), ethylene-propylene copolymers and copolymers of ethylene with other olefinic unsaturated compounds are also used to produce floor coverings.

For example, DE 10 2013 100 244 A1 discloses a PVC-free flooring including an upper decorative nonwoven fabric layer bonded without the use of adhesive to an intermediate extruded polymeric layer, preferably comprising a thermoplastic polyurethane or elastomer, and an extruded lower base layer bonded without the use of adhesive to the intermediate polymeric layer. However, the PVC-free flooring is flexible and does not provide adequate dimensional stability.

Such multilayer plastic webs, sheets or panels used as a floor covering generally consist of several layers, at least of a transparent cover layer or wear layer, respectively (also known as a wear surface, clear layer or clear film) and a base layer (also known as base film), which may be also referred to as carrier sheet or board and support sheet or board, respectively. Optionally, the edge of the carrier board may be provided with a groove, by which an adhesive-free installation of the plastic sheet or board is made possible in the form of a tongue and groove connection, where in each case a thin ridge, i.e. the tongue, and on the opposite side a groove are provided on the edge of the carrier board.

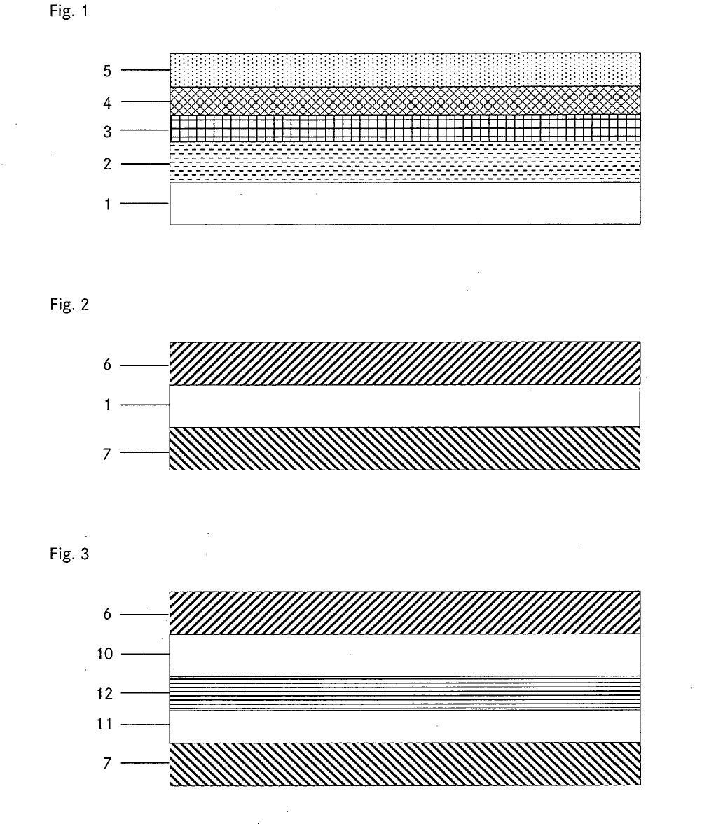

As shown schematically in FIG. 1, further layers are commonly provided between the cover layer (5) and the carrier board made of plastic (1). Usually, a glass-fiber reinforced plastic layer (GFRP layer) (2) is arranged on the carrier board made of plastic (1), for example in the form of a glass-fiber mat, which is intended to contribute to the increase of the dimensional stability of the plastic sheet or board. It is also possible that a multiplicity of GFRP layers are incorporated in such plastic sheets or boards, wherein these layers may be also arranged in the carrier or support board.

As it is also shown schematically in FIG. 1, printed decorative plastic films (4), which are also referred to as a print film, white film, printing film, printed carrier or printed white film, are commonly provided on the GFRP layer (2). These decorative films provide the plastic sheet or board with a desired appearance. In addition, one or more intermediate layer(s) (3) are often incorporated into the plastic sheet or board, in particular between the transparent cover layer (5) and the GFRP layer (2), serving to provide an opaque base layer for the printed plastic films and hence hide the subjacent GFRP layer.

Conventionally, the individual films are joined together by means of an automatic laminating machine (also designated as AUMA) by applying pressure at high temperatures.

In the plastic sheets or boards known in the prior art, however, a distortion-free imaging of decors, intended to give the lifelike imitation of, for example wood grain or stone patterns, is problematic. The reason for the improper image commonly resides in the thermal deformability of the decorative film consisting of thermoplastic materials. Mostly, these deformations arise during the manufacturing process, but also during subsequent thermal stresses and mechanical stresses during the application, such as a focused load by a case leg, for example. Another disadvantage of the multilayer plastic sheets or boards known in the art is that the decorative films as well as the intermediate layers do not have a mechanical shape-stabilizing effect. Plastic sheets or boards, which are used as ceiling, wall and floor coverings, however, require a certain dimensional stability. As mentioned above, for this reason, GFRP layers are often incorporated into multilayer plastic sheets or boards. However, internal GFRP layers provided in the center of the plastic sheet or board, which are arranged between the carrier board and decor films and/or other intermediate layers, only provide insufficient dimensional stability. The low dimensional stability becomes particularly significant, if the multilayer plastic sheets are exposed to higher temperatures.

Recently, the use of GFRP layers in plastic sheets or boards also proves to be problematic in that a later necessary recycling process, such as in the disposal of old sheets or boards or of production waste, is very complex and thus associated with significant additional costs. Due to their advantageous properties, such as corrosion resistance, durability, high stability, meanwhile, glass-fiber reinforced plastics are considered as important, but expensive materials. Not only from economical aspects, the recycling of GFRP-containing materials is therefore desirable, yet a big especially costly challenge. Besides health problems associated particularly with the fiberglass dust, the recycling of GFRP-containing materials is also problematic for the devices to be used in terms of the abrasive nature of the fiberglass filaments.

Also, laminate floorings, which are multilayer synthetic flooring products fused together during a lamination process, are well known for many years. These non-elastic laminate floorings principally comprise a support layer on which several layers with different features are laminated. In particular, specific layers which should provide a pattern or special designs are commonly used in such laminate floorings. Within recent years, several efforts have been made to combine the advantages of the non-elastic laminate floorings with those of flexible floorings, particularly with PVC floor coverings. Initial attempts were based on the idea to affix flexible, particularly PVC-floorings, on wood based panels used as support. In particular, luxury vinyl tiles (LVT) affixed on non-elastic supports were considered to have beneficial properties e.g. the ease of installation. However, these attempts did not result in competitive floorings as the manufacturing costs are far too high.

Recently, progress had been made to overcome the aforementioned drawbacks. The recent developments enable to “blow-up” common PVC-floorings, particularly 2 mm LVT floorings to about 5 mm. These floorings, due to their thickness, allow the shaping of the edge profile according to which specific designs can be employed allowing an easy installation by e.g. so-called click-systems. However, since sustainability as well as health issues become nowadays more and more a main issue, it would be desirable to avoid the use of PVC-based materials for the production of webs or sheets which are used mainly indoors on a large scale.

Therefore, one object of the present invention is to provide a multilayer decorative plastic sheet or board with excellent optical appearance which is suitable for use in interior design, especially as ceilings, linings, wall panels, decorative films or synthetic veneers for furniture as well as for floor coverings, which can be produced in an efficient and cost-effective manner and in which the use of GFRP layers to increase the dimensional stability may be omitted. Another object of the present invention is to provide a method with which such a multilayer decorative plastic sheet or board can be produced easily and inexpensively, whereby traditional machines still can be used for the production of such composite materials without any great increase in equipment expense.

These objectives are achieved by the embodiments characterized in the claims, with advantageous and preferred embodiments of this invention being characterized in the dependent claims.

In particular, the present invention provides a multilayer decorative plastic web or board, comprising a carrier sheet made of a thermoplastic material filled with powdery and/or fibrous material, and at least one layer containing an impregnated paper provided on the upper and/or lower side of the carrier sheet.

According to the present invention, the at least one paper-containing layer is impregnated, wherein the term “impregnated” is understood such that the raw paper is treated with an impregnating solution or dispersion. That is, the raw paper is impregnated, soaked or filled with impregnating solutions or dispersions conventionally used for the said purpose. According to the present invention, the raw paper may be impregnated in such a way that the paper is not completely impregnated. Such papers are also known as pre-impregnated papers. This partial impregnation can be already done during the paper manufacturing process. According to the present invention, the at least one layer containing an impregnated paper includes also all raw papers, which are subsequently filled or impregnated. Such papers may be also referred to as post-impregnated papers.

According to the present invention, the terms “web”, “board” and “sheeting” have to be understood in their broadest sense and generally refer to leveled structures and articles which may be flat or have a specific shape of concave or convex surfaces.

According to a preferred embodiment of the present invention, the multilayer decorative plastic web or board comprises at least one decorative layer containing an impregnated paper on the upper side of the carrier sheet. Said decorative layer containing an impregnated paper may be also referred to as decorative paper layer and paper film, respectively.

According to a further preferred embodiment, the multilayer decorative plastic web or board further comprises at least one layer containing an impregnated paper on the lower side of the carrier sheet.

Preferably, the multilayer decorative plastic web or board according to the present invention comprises at least one decorative layer containing an impregnated paper on the upper side of the carrier sheet and at least one layer containing an impregnated paper on the lower side of the carrier sheet.

According to a further preferred embodiment of the present invention, the carrier sheet of the multilayer decorative plastic web or board comprises a first carrier sheet made of a thermoplastic material, a second carrier sheet made of a thermoplastic material, and a middle layer provided between the first carrier sheet and the second carrier sheet, which comprises a powdery and/or fibrous material interspersed or laid therebetween. According to the present invention, the thermoplastic material to be used for manufacturing the first carrier sheet may be the same as or different from the thermoplastic material to be used for manufacturing the second carrier sheet.

According to a particularly preferred embodiment, the multilayer decorative plastic web or board according to the present invention further comprises at least one vapor permeable adhesion layer provided between the carrier sheet, which may be in form of the aforementioned carrier sheet including the first and second carrier sheets and the middle layer, and the at least one layer containing an impregnated paper, wherein the adhesion layer is present at least in parts of the interface between the carrier sheet and the at least one layer containing an impregnated paper.

Preferably, the multilayer decorative plastic web or board according to the present invention further comprises a transparent cover layer provided on the outermost surface of the at least one layer containing an impregnated paper facing away from the carrier sheet. In particular, the transparent cover layer is preferably provided on the decorative layer containing an impregnated paper on the upper side of the carrier sheet.

According to another preferred embodiment of the multilayer decorative plastic web or board according to the present invention, the at least one layer containing an impregnated paper, particularly the decorative layer containing an impregnated paper on the upper side of the carrier sheet, has an ink-receiving layer provided on the surface facing away from the carrier sheet. In such a case, it is preferred that the decorative layer containing an impregnated paper carries a digital print.

The multilayer decorative plastic web or board according to the present invention may further comprise at least one elastic layer provided between the carrier sheet and the at least one layer containing an impregnated paper. According to the present invention, said elastic layer, e.g. a foam layer, is capable to balance shear forces between the specific layers of the multilayer decorative plastic web or board.

According to another preferred embodiment, the transparent cover layer is an acrylic-based varnish or a polyurethane-based varnish.

In another preferred embodiment, the thickness of the multilayer decorative plastic web or board according to the present invention is ranging from 3 to 5 mm.

The edge profile of the multilayer decorative plastic web or board according to the present invention is preferably shaped enabling the installation by means of a click-joint or by means of a tongue and groove joint.

The present invention is based on the finding that the replacement of a printed decorative plastic film particularly by a decorative impregnated paper containing layer in a multilayer decorative plastic sheet or board advantageously enables a distortion-free imaging of decors. This is because the impregnated paper-containing layer undergoes no thermal deformation at the processing temperatures. According to the present invention, it was also found that in the presence of a second impregnated paper-containing layer as shape-stabilizing backing layer, which is provided on the lower side (back side) of the carrier sheet (or carrier/support board) of a plastic sheet or board, the resultant plastic web or board has an increased dimensional stability.

By this inventive construction of a decorative plastic web or board (sandwich structure), as shown in FIG. 2, according to which a second impregnated paper-containing layer is used as backing layer, it is advantageously possible to avoid the use of internal glass-fiber layers (GFRP layers), since this sandwich structure exhibits an increased dimensional stability in comparison to known plastic boards, even when exposed to higher temperatures.

As mentioned above, due to the increased dimensional stability resulting from the sandwich structure, in which two impregnated paper-containing layers function in terms of an external skeleton, it is possible to omit the use of expensive fiber-glass materials. Simultaneously, the multilayer decorative plastic web or board according to the present invention solves the aforementioned recycling problems, because no fiber-glass layers have to be processed, while the use of sustainable raw materials can be increased. For this reason, the multilayer decorative plastic web or board according to the present invention is characterized by a good environmental balance.

Due to the increased dimensional stability, it is also possible to decrease the thickness of the multilayer decorative plastic web or board according to the present invention, particularly of the carrier layer, which results in further economic and environmental advantages in comparison with known prior art plastic boards.

The present invention also relates to a method for producing the multilayer decorative plastic web or board according to the present invention.

In particular, the present invention further provides a method for producing said multilayer decorative plastic web or board, comprising the steps of:
applying a thermoplastic material onto a conveyor belt by means of at least one first material distributor arranged above the conveyor belt;
providing a powdery and/or fibrous material onto the thermoplastic material and subjecting the thermoplastic material to a thermofixation step to form a heated initial carrier layer; and
laminating at least one layer containing an impregnated paper onto the heated initial carrier layer.

The present invention will be described in more detail herein-below with respect to the following embodiments along with the accompanying drawings, wherein

FIG. 1 shows the structure of conventional plastic boards,

FIG. 2 shows a preferred embodiment of the present invention,

FIG. 3 shows a particularly preferred embodiment of the present invention,

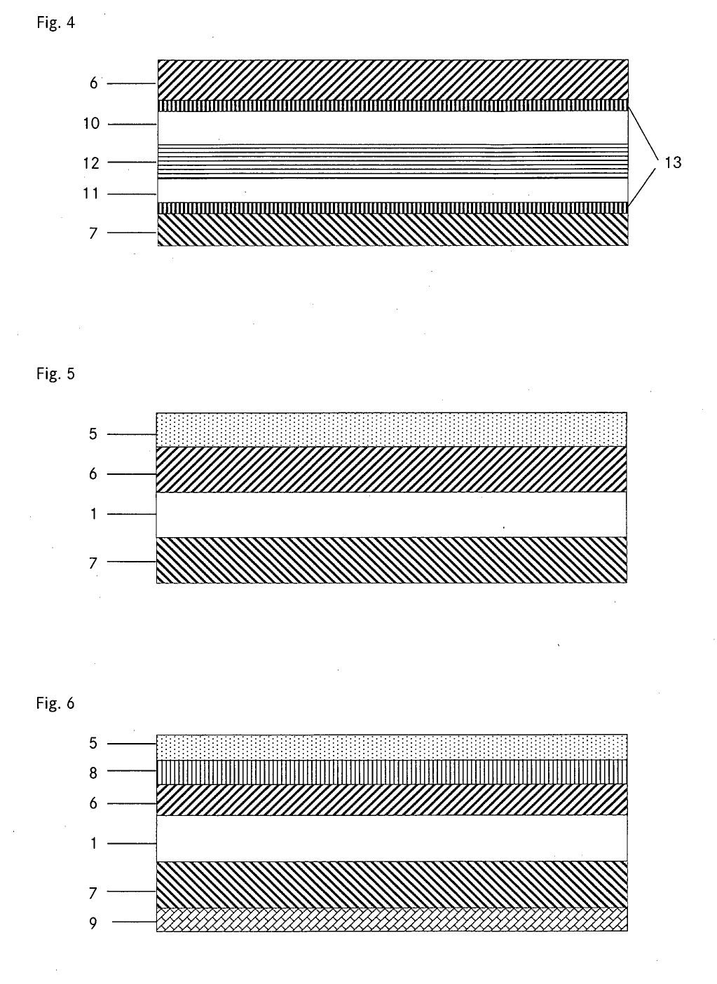

FIG. 4 shows a further preferred embodiment of the present invention,

FIG. 5 shows another preferred embodiment of the present invention, and

FIG. 6 shows still another preferred embodiment of the present invention.

The multilayer decorative plastic web or board according to the present invention comprises a carrier sheet made of a thermoplastic material filled with powdery and/or fibrous material, and at least one layer containing an impregnated paper provided on the upper and/or lower side of the carrier sheet. According to the present invention, the carrier sheet, which may be also referred to as carrier board, support sheet or support board, is made of a thermoplastic material filled with powdery and/or fibrous material. The thermoplastic material is not specifically limited and all known thermoplastic (co)polymers may be used. For example, the thermoplastic material may be selected from acrylonitrile butadiene styrene (ABS), polyamide (PA), polylactate (PLA), polymethyl(meth)acrylate (PMMA and PMA), polycarbonate (PC), polyethylene terephthalate (PET), polyethylene (PE), polypropylene (PP), polystyrene (PS), polyetheretherketone (PEEK), polyvinyl chloride (PVC), and corresponding copolymers or mixtures thereof. Preferably, the thermoplastic material contained in the carrier board is selected from the group consisting of PVC, PP, PE, PLA, and copolymers thereof, and mixtures thereof.

According to the present invention, the thermoplastic carrier sheet comprises a powdery and/or fibrous material. Examples of the powdery and fibrous filling material include organic reinforcing materials, synthetic and natural fibers, which are preferably based on renewable resources, or mixtures or blends thereof. Preferably, the filling material is selected from chalk, wood or saw dust, and textile fibers, which may have a coating. However, the present invention is not limited to these. The content of the filling material may range from 5 to 80 wt.-%, preferably from 10 to 60 wt.-%, more preferably from 15 to 40 wt.-% based on the total weight of the carrier sheet.

As it is shown in FIG. 2, the carrier sheet (1) made of the thermoplastic material filled with powdery and/or fibrous material may be in the form of a single layer. According to a preferred embodiment of the present invention, the carrier sheet of the multilayer decorative plastic web or board comprises a first carrier sheet (10) and a second carrier sheet (11) made of a thermoplastic material, which may be different from each other, as it is shown in FIG. 3. According to the present invention, a middle layer (12) is preferably provided between the first carrier sheet (10) and the second carrier sheet (11). The middle layer (12) comprises a powdery and/or a fibrous, preferably a fibrous material, which is interspersed or laid between the carrier layers. The middle layer (12) comprises the aforementioned filling material, which is preferably in form of fibers. Such fibers may be applied with or without binder.

According to the present invention, the fibers' orientation in the carrier sheet or in the middle layer is preferably anisotropic. Such an anisotropic orientation of the fibers counteracts a potential delamination of the specific layers, particularly the carrier sheets. The dimensions of the fibers in terms of their size and length are not particularly limited and can be varied according to the requirements of the relevant application.

As mentioned above, the powdery or fibrous filling material may be interspersed or laid down onto the carrier sheet or in-between the carrier sheets, respectively. To this extent, it should be noted that conventional multilayer webs or boards, which are manufactured upon lamination, have plane joinings and interfaces, respectively, between the respective layers or films. These, however, are considered to be commonly the cause for a potential delamination of the specific layers. To the contrary, due to the presence of the powdery and/or fibrous material, depending on their size and length, the surface between the specific layers becomes rough, thereby improving the delamination characteristics as the specific layers can interlock each other.

According to the present invention, besides the fibrous filling material, which is preferably present in form of the middle layer (12), the carrier sheet(s) may further comprise additional filling materials, such as additives. Preferably, additives which improve the thermal conductivity are contained in the carrier sheet(s). In particular, according to the present invention, the carrier sheet(s) preferably further contain(s) at least one additive such as graphite, expanded graphite, carbon black and lava dust, wherein expanded graphite is particularly preferred, since expanded graphite can beneficially lower the density of the multilayer decorative plastic web or board.

In addition, the carrier sheet(s) may further contain additives for improving the electrical conductivity and/or antistatic properties of the multilayer decorative plastic web or board. In particular, the carrier sheet(s) may contain at least one electrically conductive metal oxide and/or at least one electrically conductive organic polymer. Such additives may be also present in form of further material layers. The electrically conductive metal oxide can be selected from the group consisting of tin oxide, indium oxide, antimony oxide, aluminum oxide, titanium oxide, oxides of the rare earths and mixtures thereof. Such metal oxides can also be doped with other metals and/or semimetals. In addition or instead of the electrically conductive metal oxide electrically conductive organic polymers can also be contained in the multilayer decorative plastic web or board. Examples of such polymers are polyanilines, polypyrroles, polyacetylenes, polythiophenes, derivatives of the preceding polymers and corresponding mixtures.

However, according to the present invention, since the electric conductivity of the impregnated paper is higher than conventional films used in multilayer webs or boards, the multilayer decorative plastic web or board according to the present invention has lower static electrical propensity compared to conventional structures. Thus, according to the present invention, in order to fulfill antistatic requirements, such as the requirements under ISO 6356, it is not necessary to add specific antistatic additives. Said characteristic is also beneficial insofar that problems associated with the provision of a specific printed design, particularly when using digital printing techniques, can be avoided, since electrostatic effects e.g. between the print heads and the substrate can be minimized. Thus, due to the presence of the at least one layer containing an impregnated paper, the multilayer decorative plastic web or board according to the present invention has preferably low static electrical propensity fulfilling the requirements under ISO 6356 without the addition of antistatic additives.

As mentioned above, conventional plastic sheets or boards commonly have a glass-fiber reinforced plastic layer (GFRP layer), e.g. in the form of a glass-fiber mat, to improve the dimensional stability. However, due to the presence of the glass-fiber mat, the density of the conventional constructions is inhomogeneous. Moreover, the coefficient of thermal expansion of such reinforcing materials differs from the remaining plastic materials. According to the present invention, employing the specific core construction, in which GFRP layers can be avoided, a strong variation in terms of the density as well as the coefficient of thermal expansion can be avoided. Thus, in the multilayer decorative plastic web or board according to the present invention, cooling related tensions can be reduced.

As it has been described above, according to the present invention, a layer containing an impregnated paper is understood as paper layer, which in terms of a raw paper layer may be treated with an impregnating solution or dispersion. According to the present invention, conventional impregnation solutions or dispersions can be used. For example, those based on thermosetting resins such as melamine resins, phenolic resins and/or urea resins, or water-soluble or water-dispersible thermoplastic materials, PVC-/polyester based dispersions or mixtures thereof can be suitably used. In addition, suitable impregnating solutions or dispersions based on renewable raw materials, such as starch, or mixtures of the above ingredients in different proportions can be used.

The impregnating solutions or resins can be thermally or chemically cured or cured by radiation, especially by using ultraviolet (UV) radiation or electron beams.

According to the present invention, as a layer containing an impregnated paper (impregnated paper-containing layer) those known in the art can be used including the aforementioned pre-impregnated papers or post-impregnated papers, as described, for example, in WO 95/17551 A1, WO 2009/000 769 A1 and DE 100 57 294 C1, which are usually characterized by a low basis weight, good opacity and high strength.

According to the present invention, the impregnated paper-containing layer is preferably a pre-impregnated paper imparting water-proofness and increased dimensional stability based on the improved internal bond strength of the fibers of the raw paper.

Based thereon, according to the present invention, each of the layers constituting the multilayer decorative plastic web or board (i.e. the carrier sheet(s), the impregnated paper-containing layer(s), and optional further discrete layers) is preferably waterproof and water-resistant, respectively.

According to a preferred embodiment of the present invention, as it is shown in FIG. 2, the multilayer decorative plastic web or board comprises at least two layers containing an impregnated paper, at least one decorative layer containing an impregnated paper (6) on the upper side of the carrier sheet and at least one layer containing an impregnated paper (7) on the lower side of the carrier sheet.

The impregnated paper-containing layer (6) provided on the upper side of the carrier sheet contains opacifying pigments and is also referred to as decorative impregnated paper-containing layer. Said decorative impregnated paper-containing layer may have a printed design. According to the present invention, the printed design may be applied before or after the impregnation of the raw paper, as well as before or after the step of applying or generating the thermoplastic carrier sheet, as will be described in more detail herein-below.

The printing method is not particularly limited. According to the present invention, printing methods or techniques known in the art can be used. However, the use of gravure printing or digital printing is preferred.

According to a preferred embodiment of the present invention, the impregnated paper-containing layer (6) comprises an ink-receiving layer (8), as it is shown in FIG. 6. Preferably, the ink-receiving layer (8) is disposed on the top side of the impregnated paper-containing layer (6), more preferably between an optional transparent cover layer (5) and the at least one decorative impregnated paper-containing layer (6). The use of an impregnated paper-containing layer with an ink receiving layer (8) thus advantageously provides the option to use digital printing techniques. This allows, for example by means of an ink-jet method, that an even higher print quality can be achieved.

The at least one decorative impregnated paper-containing layer (6) acting as an opaque decor layer serves as a design carrier allowing a big variation of desired decorations, such as for example lifelike wood grain or natural stone patterns, or other desired designs. Preferably, the multilayer decorative plastic web or board according to the present invention comprises one decorative impregnated paper-containing layer (6).

According to a preferred embodiment of the present invention, in addition to the aforementioned decorative impregnated paper-containing layer (6), the multilayer decorative plastic web or board further comprises at least one layer containing an impregnated paper (7) on the lower side of the carrier sheet (i.e. at the bottom or rear side of the carrier sheet). Said second impregnated paper-containing layer (7) acts as a backing layer and further increases the dimensional stability of the multilayer decorative plastic web or board according to the present invention. The impregnated paper-containing layer (7) may be made of the same material as the decorative impregnated paper-containing layer (6). However, it is not necessary that said backing layer comprises opacifyers or an ink-receiving layer, but may comprise a print showing, for example a logo or the like.

The backing layer may comprise a magnetizable material. Suitable ferromagnetic materials are known to a person skilled in the art and as non-limiting examples, iron-based or copper-based additives may be mentioned.

According to a preferred embodiment, the at least one impregnated paper-containing layer (6, 7) is provided with an adhesion layer which is present at least in parts of the interface between the carrier sheet(s) and the at least one impregnated paper-containing layer (6, 7). Preferably, the decorative impregnated paper-containing layer (6) comprises on the surface facing the carrier sheet (i.e. its back side) an adhesion layer, while the impregnated paper-containing layer (7) (backing layer) comprises on the surface facing the carrier sheet (i.e. its front side) an adhesion layer.

A particularly preferred embodiment is shown in FIG. 4, according to which a vapor permeable adhesion layer (13) is disposed at each interface between the impregnated paper-containing layers (6, 7) and the carrier sheets (10, 11). According to the present invention, the adhesion layer (13) is present at least in parts of the respective interfaces. The adhesion layer (13) may be continuously or partly present on the interface. According to the present invention, the adhesion layer (13) may be smooth or furnished with a surface texture. As will be apparent for a person skilled in the art, in case the multilayer decorative plastic web or sheet according to the present invention further comprises a transparent cover layer, as will be discussed in more detail herein-below, a vapor permeable adhesion layer may be also disposed at the interface between the impregnated paper-containing layer (6) and the transparent cover layer. Moreover, according to the present invention, the vapor permeable adhesion layer (13) may be also present only on both surfaces of the impregnated paper-containing layer (6), and thus the present invention is not restricted to the embodiment shown in FIG. 4.

According to the present invention, the adhesion layer (13) can be vapor permeable insofar that any gaseous vapor generated during the manufacturing process, particularly in the lamination step, can permeate from the thermoplastic carrier sheets (10, 11) including the middle layer (12) through the adhesion layer (13) or through the edges. Based thereon, a possible weakening of the adhesion between the various layers can be avoided as, for example, the generation of bubbles possibly embedded between the specific layers including the carrier sheets, the impregnated paper-containing layers as well as the transparent cover layer, can be avoided. Consequently, a possible delamination caused by the decrease of the adhesion strength of the adhesion layer between the specific layers can be minimized, resulting in an improved quality of the multilayer decorative plastic web or board according to the present invention.

The adhesion layer may be extruded or thermally applied or laminated onto the impregnated paper-containing layer(s). Alternatively, the adhesion layer may be printed or flaked on the impregnated paper-containing layer(s). In addition, the adhesion layer may be also applied during the preparation of the impregnated paper- containing layer(s) in terms of a resin paste. Further, the adhesion layer may be modified with plasma treatment. According to the present invention, the adhesion layer also advantageously reduces the swelling ability of the paper fibers.

The adhesion agent is not particularly limited and is adjusted depending on the type of the thermoplastic material used for the carrier sheet.

According to another preferred embodiment of the present invention, the multilayer decorative plastic web or board further comprises a transparent cover layer (5) provided on the outermost surface of the at least one layer containing an impregnated paper (6) facing away from the carrier sheet (1) to protect the decor layer, as shown in FIG. 5. In this context, it should be noted that in FIG. 5, in terms of clarity, the specific layers (10) to (13) are omitted. Thus, each specific embodiment shown in FIGS. 2 to 4 may further comprise a transparent cover layer (5).

According to the present invention, the cover layer (5) is preferably an abrasion-resistant finish that can be selected depending on the intended purpose. In particular, varnishes can be applied to seal the surface of the decorative impregnated paper-containing layer (6), which are preferably selected from an acrylic-based varnish or polyurethane-based varnish. These may be thermally or chemically cured or cured by radiation, especially by using ultraviolet (UV) radiation or electron beams.

The applied coatings representing the cover layer (5) may contain other ingredients which may cause corresponding advantageous properties of the coating depending on the application, such as the aforementioned abrasion characteristics or anti-slip characteristics. These additional ingredients are well known to the skilled person and need not be listed in detail. For example, additives, pigments, inorganic or organic additives and solvents known in the art may be mentioned.

Preferably, the coating materials contain inorganic pigments such as silicas, silicates or aluminum oxide so as to improve abrasion resistance and flame retarding properties.

According to a preferred embodiment of the present invention, a solvent-free coating material is used, wherein a varnish based on renewable raw materials is even more preferred. In such a case, binders based on vegetable oils and/or sugars may be used for example, whereby the use of binders based on petroleum can be advantageously minimized. Renewable raw materials include organic raw materials derived from agricultural and forestry production. For example, wood, natural fibers, vegetable oils, sugar and starch, chemical and pharmacological raw materials and raw materials of animal origin may be mentioned. According to the present invention, the term “renewable raw materials” also includes products derived from renewable raw materials, which have been subjected to one or more passes or modification steps.

According to a preferred embodiment of the present invention, the transparent cover layer (5) may have an embossing. This can, for example, be in terms of an irregular embossing, for example, as a fine embossing for dulling the surface. In addition, an embossing of the transparent cover layer (5) can beneficially provide an anti-slip property to the wear layer side. Said embossing can also provide a three-dimensional appearance to the multilayer decorative plastic web or board according to the present invention. Thus, such an embossing may be used in terms relating to the appearance and/or in functional terms (e.g. to provide anti-slip properties).

As shown in FIG. 6, the multilayer decorative plastic web or board according to the present invention may further comprise an additional coating (9) composed of a thermoplastic polymer. Such an additional coating layer (9) may be provided at the lower side of the impregnated paper-containing layer (7) facing away from the carrier sheet. Preferably, such an additional coating layer (9) may be composed of PE, PP or a copolymer of PE and PP, providing an additional moisture proof to the multilayer decorative plastic web or board. Said additional coating layer (9) may be laminated onto the impregnated paper-containing layer (7). Said thermoplastic polymer may adopt the embossing structure of the belts during manufacture by which the surface can be increased resulting in an improved gluability.

Additionally, the multilayer decorative plastic web or board according to the present invention may further comprise at least one elastic layer disposed on the impregnated paper-containing layer(s) (6, 7) facing the carrier sheet. Said at least one elastic layer can be applied to balance shear forces between the specific layers of the multilayer decorative plastic web or board according to the present invention, such as an open celled foam layer. Preferably, the elastic layer comprises a non-thermoplastic material having high internal cohesion. In addition, the elastic layer should be highly resilient and should have high elasticity while having a rather small elongation resistance and compression. As non-limiting examples, the elastic layer may be made of foam rubber or expanded rubber including open celled sponge rubbers which may be made from polyurethane or natural latex.

The thickness of the multilayer decorative plastic web or board according to the present invention is not particularly limited and merely depends on the intended use, i.e. whether the plastic web or board is used as ceiling, lining, wall panel, decorative film, synthetic veneer or floor covering. Preferably, the thickness of the multilayer decorative plastic web or board according to the present invention is ranging from 2 to 8 mm, more preferably from 3 to 5 mm.

Further, the edge profile of the multilayer decorative plastic web or board according to the present invention is preferably shaped enabling the installation by means of a click-joint or by means of a tongue and groove joint.

To produce the multilayer decorative plastic web or board according to the present invention, the equipment and devices and machinery conventionally used for the production of e.g. floor covering may be used, saving costs for additional or specific equipment and devices. For example, the multilayer decorative plastic web or board according to the present invention may be produced by using a low-pressure thermofixation system, or a conventional automatic high-pressure laminating machine (also designated as AUMA), a Doppelbandauma or a double belt press.

In particular, according to the present invention, the multilayer decorative plastic web or board can be produced by a method, comprising the steps of:
applying the thermoplastic material onto a conveyor belt by means of at least one first material distributor arranged above the conveyor belt;
providing a powdery and/or fibrous material onto the thermoplastic material and subjecting the thermoplastic material to a thermofixation step to form a heated initial carrier layer; and
laminating at least one layer containing an impregnated paper onto the heated initial carrier layer.

Preferably, the thermoplastic material is applied onto the conveyor belt in form of pellets. In particular, the thermoplastic material may be spread onto a belt of a fixation system known in the art, particularly of a low-pressure thermofixation system, a belt of a Thermofix®-machine, upon which the pellets of the milled or ground thermoplastic material will be fixed and further processed.

Accordingly, the impregnated paper-containing layers (6, 7) may be separately produced and are preferably laminated to the thermoplastic carrier sheet(s) representing the core of the multilayer decorative plastic web or board according to the present invention.

According to the present invention, the multilayer decorative plastic web or board may be preferably produced by employing the methods and devices described in EP 1 045 751 B1, DE 10 2007 063 261 A1 as well as WO 2012/016916 A1, respectively, which are incorporated herein by reference.

As mentioned above, if the thermoplastic carrier sheet contains further additives e.g. for improving the electrical conductivity and/or antistatic properties, these may be admixed to the thermoplastic material before the fixation step.

As already outlined above, the obtained multilayer decorative plastic web or board according to the present invention can be provided easily and inexpensively and can be used for interior design, preferably as wall panels, ceilings, decorative films, synthetic veneer and in particular as a floor covering. These can be provided as rollable sheets, tiles, panels and the like.

### LIST OF REFERENCE NUMERALS

1 carrier sheet made of a thermoplastic material

2 glass-fiber reinforced plastic layer

3 interlayer

4 decorative films made of plastic

5 transparent cover layer p 6 decorative layer containing an impregnated paper (impregnated paper-containing decorative layer)

7 layer containing an impregnated paper (impregnated paper-containing layer)

8 ink-receiving layer

9 coating having a thermoplastic polymer

10 first carrier sheet made of a thermoplastic material

11 second carrier sheet made of a thermoplastic material

12 middle layer

13 vapor permeable adhesion layer

1. A multilayer decorative plastic web or board, comprising
a carrier sheet made of a thermoplastic material filled with powdery and/or fibrous material, and
at least one layer containing an impregnated paper provided on the upper and/or lower side of the carrier sheet.

2. The multilayer decorative plastic web or board according to claim 1, comprising at least one decorative layer containing an impregnated paper on the upper side of the carrier sheet and at least one layer containing an impregnated paper on the lower side of the carrier sheet.

3. The multilayer decorative plastic web or board according to claim 2, wherein the carrier sheet comprises a first carrier sheet made of a thermoplastic material, a second carrier sheet made of a thermoplastic material, and a middle layer provided between the first carrier sheet and the second carrier sheet, which comprises a powdery and/or fibrous material interspersed or laid therebetween.

4. The multilayer decorative plastic web or board according to claim 1, further comprising at least one vapor permeable adhesion layer provided between the carrier sheet and the at least one layer containing an impregnated paper, wherein the adhesion layer is present at least in parts of the interface between the carrier sheet and the at least one layer containing an impregnated paper.

5. The multilayer decorative plastic web or board according to claim 1, further comprising a transparent cover layer provided on the outermost surface of the at least one layer containing an impregnated paper facing away from the carrier sheet.

6. The multilayer decorative plastic web or board claim 1, wherein the at least one layer containing an impregnated paper has an ink-receiving layer provided on the surface facing away from the carrier sheet.

7. The multilayer decorative plastic web or board according to claim 6, wherein the at least one layer containing an impregnated paper carries a digital print.

8. The multilayer decorative plastic web or board according to claim 1, further comprising at least one elastic layer provided between the carrier sheet and the at least one layer containing an impregnated paper.

9. The multilayer decorative plastic web or board according to claim 5, wherein the transparent cover layer is an acrylic-based varnish or a polyurethane-based varnish.

10. The multilayer decorative plastic web or board according to claim 1 wherein the web or board has a thickness of from 3 to 5 mm.

11. The multilayer decorative plastic web or board according to claim 1, wherein the edge profile is shaped enabling the installation by means of a click-joint or by means of a tongue and groove joint.

12. A method for producing a multilayer decorative plastic web or board according to claim 1, comprising the steps of:
applying a thermoplastic material onto a conveyor belt by means of at least one first material distributor arranged above the conveyor belt;
providing a powdery and/or fibrous material onto the thermoplastic material and subjecting the thermoplastic material to a thermofixation step to form a heated initial carrier layer; and
laminating at least one layer containing an impregnated paper onto the heated initial carrier layer.

13. The method for producing a multilayer decorative plastic web or board according to claim 12, wherein the thermoplastic material is applied onto the conveyor belt in form of pellets.

14. (canceled)

15. A ceiling, lining, wall panel, decorative film or synthetic veneer for furniture, or for floor covering comprising the multilayer decorative plastic web or board according to claim 1.
